(19) United States
(12) Patent Application Publication
(10) Pub. No.: US 2025/0191043 A1
(43) Pub. Date: Jun. 12, 2025

(54) METHOD, TERMINAL APPARATUS, AND NON-TRANSITORY COMPUTER READABLE MEDIUM

(71) Applicant: TOYOTA JIDOSHA KABUSHIKI KAISHA, Toyota-shi Aichi-ken (JP)

(72) Inventors: Yuho KATO, Nagoya-shi Aichi-ken (JP); Yosuke KAMADA, Yokohama-shi Kanagawa-ken (JP); Satoshi Kume, Nagakute-shi Aichi-ken (JP); Satoru SAKUMA, Nagakute-shi Aichi-ken (JP); Takeshi TAKEMOTO, Nagoya-shi Aichi-ken (JP); Shintaro MATSUTANI, Kariya-shi Aichi-ken (JP)

(73) Assignee: TOYOTA JIDOSHA KABUSHIKI KAISHA, Toyota-shi Aichi-ken (JP)

(21) Appl. No.: 18/975,118

(22) Filed: Dec. 10, 2024

(30) Foreign Application Priority Data
Dec. 12, 2023 (JP) 2023-209659

(51) Int. Cl. G06Q 30/0601

(52) U.S. Cl. CPC G06Q 30/0621; G06Q 30/0631

(57) ABSTRACT

A method performed by a terminal apparatus includes acquiring, via a communication interface, recommendation information indicating a recommended option determined based on preference information indicating a user's preference regarding vehicles, outputting the recommended option via an output interface, accepting, via an input interface, a selection of an option that the user wishes to purchase, and transmitting, via the communication interface to an information processing apparatus, selection information indicating the option selected by the user.

### CROSS-REFERENCE TO RELATED APPLICATION

This application claims priority to Japanese Patent Application No. 2023-209659 filed on Dec. 12, 2023, the entire contents of which are incorporated herein by reference.

### TECHNICAL FIELD

The present disclosure relates to a method, a terminal apparatus, and a program.

### BACKGROUND

Conventionally, there is technology for providing various types of information, such as price information on products desired by users, to information terminals used by the users online via communication lines. For example, Patent Literature (PTL) 1 discloses technology that enables users to refer to selection information by third parties when the users select specifications for individually-specified vehicles.

### CITATION LIST

### Patent Literature

PTL 1: JP 2004-054774 A

### SUMMARY

When users select options at the time of purchasing vehicles, a large number of options available may cause the users to dither over which options to select. Therefore, there is room for improvement with respect to technology for assisting users when the users purchase options for vehicles.

A method according to the present disclosure is a method performed by a terminal apparatus including an input interface, an output interface, a communication interface configured to communicate with an information processing apparatus that provides a sales site for options for vehicles, and a controller, the method including:
acquiring, by the controller via the communication interface, recommendation information indicating a recommended option determined based on preference information indicating a user's preference regarding vehicles;
outputting, by the controller, the recommended option via the output interface;
accepting, by the controller via the input interface, a selection of an option that the user wishes to purchase; and
transmitting, by the controller via the communication interface to the information processing apparatus, selection information indicating the option selected by the user.

A terminal apparatus according to the present disclosure is a terminal apparatus including:
an input interface;
an output interface;
a communication interface configured to communicate with an information processing apparatus that provides a sales site for options for vehicles; and
a controller configured to:
   acquire, via the communication interface, recommendation information indicating a recommended option determined based on preference information indicating a user's preference regarding vehicles;
   output the recommended option via the output interface;
   accept, via the input interface, a selection of an option that the user wishes to purchase; and
   transmit, via the communication interface to the information processing apparatus, selection information indicating the option selected by the user.

A program according to the present disclosure is configured to cause a computer as a terminal apparatus to execute operations, the terminal apparatus including an input interface, an output interface, a communication interface configured to communicate with an information processing apparatus that provides a sales site for options for vehicles, and a controller, the operations including:
acquiring, via the communication interface, recommendation information indicating a recommended option determined based on preference information indicating a user's preference regarding vehicles;
outputting the recommended option via the output interface;
accepting, via the input interface, a selection of an option that the user wishes to purchase; and
transmitting, via the communication interface to the information processing apparatus, selection information indicating the option selected by the user.

According to the present disclosure, it is possible to improve technology for assisting users when the users purchase options for vehicles.

### BRIEF DESCRIPTION OF THE DRAWINGS

In the accompanying drawings:

FIG. 1 is a diagram illustrating a configuration of a system according to a first embodiment;

FIG. 2 is a flowchart illustrating operations of the system according to the first embodiment;

FIG. 3 is a diagram illustrating a recommended option output to a terminal apparatus according to the first embodiment;

FIG. 4A is a flowchart illustrating operations of a system according to a second embodiment; and

FIG. 4B is a flowchart illustrating operations of the system according to the second embodiment.

### DETAILED DESCRIPTION

### First Embodiment

A first embodiment of the present disclosure will be described below, with reference to the drawings. In the drawings, the same or corresponding portions are denoted by the same reference numerals. In the descriptions of the present embodiment, detailed descriptions of the same or corresponding portions are omitted or simplified, as appropriate.

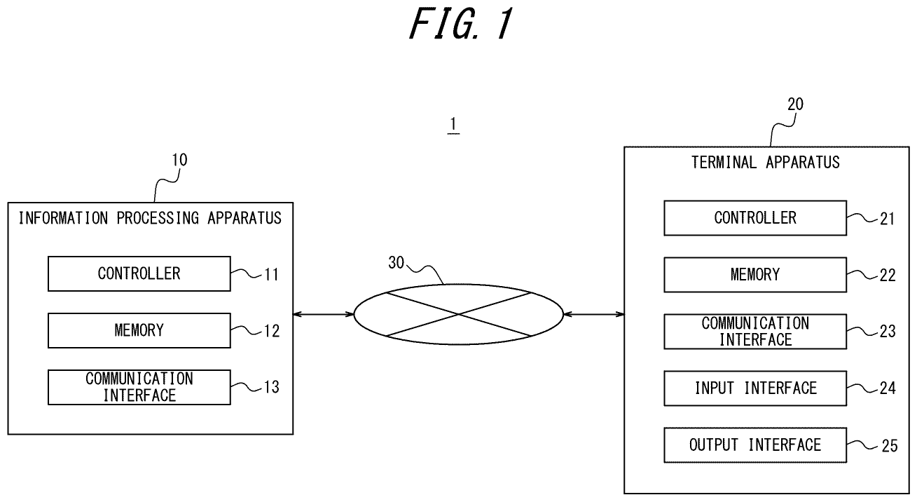

A configuration of a system 1 according to the present embodiment will be described with reference to FIG. 1. The system 1 includes an information processing apparatus 10 and a terminal apparatus 20. The information processing apparatus 10 can communicate with the terminal apparatus 20 via a network 30.

The information processing apparatus 10 is a computer installed in a facility such as a data center. The information processing apparatus 10 is operated by a business operator that sells options for vehicles. The information processing apparatus 10 provides a sales site for the vehicles and the options for the vehicles.

The terminal apparatus 20 is held by a user. The terminal apparatus 20 is, for example, a mobile device such as a mobile phone, a smartphone, or a tablet, or a PC. The term “PC” is an abbreviation of personal computer.

The network 30 includes the Internet, at least one WAN, at least one MAN, or any combination thereof. The term “WAN” is an abbreviation of wide area network. The term “MAN” is an abbreviation of metropolitan area network. The network 30 may include at least one wireless network, at least one optical network, or any combination thereof. The wireless network is, for example, an ad hoc network, a cellular network, a wireless LAN, a satellite communication network, or a terrestrial microwave network. The term “LAN” is an abbreviation of local area network.

First, an outline of the present embodiment will be described, and details thereof will be described later. The terminal apparatus 20 acquires, from the information processing apparatus 10, recommendation information indicating a recommended option determined based on preference information indicating the user's preferences regarding vehicles. The terminal apparatus 20 outputs the recommended option, and accepts a selection of an option that the user wishes to purchase. The information processing apparatus 20 transmits, to the information processing apparatus 10, selection information indicating the option selected by the user.

The options for the vehicles can be selected and purchased by the user when the user purchases a vehicle. Some options for the vehicles can be selected in place of or in addition to standard equipment of the vehicle the user is purchasing. The options specifically include any type of body colors, seat materials and colors, heated seats, navigation devices, door mirrors, rearview monitors, air purifiers, and the like. The user's preferences regarding the vehicles include preferred vehicle specifications, purposes of riding, destinations to be visited by vehicle, and the like. The vehicle specifications include interior or exterior atmosphere, and the like. The purposes of riding include shopping, commuting, drop-off and pick-up, and the like. According to the present embodiment, the recommended option that matches the user's preferences are displayed in a supplementary manner, thus reducing the likelihood that the user dithers over or feels cumbersome when selecting the option. Therefore, it is possible to improve technology for assisting users when the users purchase options for vehicles.

A configuration of the information processing apparatus 10 according to the present embodiment will be described with reference to FIG. 1. The information processing apparatus 10 includes a controller 11, a memory 12, and a communication interface 13.

The controller 11 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 11 executes processes related to operations of the information processing apparatus 10 while controlling components of the information processing apparatus 10.

The memory 12 includes at least one semiconductor memory, at least one magnetic memory, at least one optical memory, or any combination thereof. The semiconductor memory is, for example, RAM, ROM, or flash memory. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The flash memory is, for example, SSD. The term “SSD” is an abbreviation of solid-state drive. The magnetic memory is, for example, HDD. The term “HDD” is an abbreviation of hard disk drive. The memory 12 functions as, for example, a main memory, an auxiliary memory, or a cache memory. The memory 12 stores information to be used for the operations of the information processing apparatus 10 and information obtained by the operations of the information processing apparatus 10.

The communication interface 13 includes at least one communication module. The communication module is, for example, a module compatible with a wired LAN communication standard such as Ethernet (Ethernet is a registered trademark in Japan, other countries, or both) or a wireless LAN communication standard such as IEEE802.11. The name “IEEE” is an abbreviation of Institute of Electrical and Electronics Engineers. The communication interface 13 communicates with apparatuses other than the information processing apparatus 10. The communication interface 13 receives information to be used for the operations of the information processing apparatus 10, and transmits information obtained by the operations of the information processing apparatus 10.

A configuration of the terminal apparatus 20 according to the present embodiment will be described with reference to FIG. 1. The terminal apparatus 20 includes a controller 21, a memory 22, a communication interface 23, an input interface 24, and an output interface 25. Hardware configurations of the controller 21, memory 22, and communication interface 23 of the terminal apparatus 20 may be the same as those of the controller 11, memory 12, and communication interface 13 of the information processing apparatus 10, respectively. A description here is omitted.

The input interface 24 includes at least one interface for input. The interface for input is, for example, a physical key, a capacitive key, a pointing device, a touch screen integrally provided with a display, or a microphone. The input interface 24 accepts an operation for inputting data to be used for the operations of the terminal apparatus 20. The input interface 24 may be connected to the terminal apparatus 20 as an external input device, instead of being included in the terminal apparatus 20. As the connection method, any technology such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 25 includes at least one interface for output. The interface for output is, for example, a display or a speaker. The display is, for example, an LCD or an organic EL display. The term “LCD” is an abbreviation of liquid crystal display. The term “EL” is an abbreviation of electro luminescence. The output interface 25 outputs data obtained by the operations of the terminal apparatus 20. The output interface 25 may be connected to the terminal apparatus 20 as an external output device, instead of being included in the terminal apparatus 20. As the connection method, any technology such as USB, HDMI®, or Bluetooth® can be used.

The functions of the information processing apparatus 10 or the terminal apparatus 20 are realized by execution of a program according to the present embodiment by a processor serving as the controller 11 or the controller 21. That is, the functions of the information processing apparatus 10 or the terminal apparatus 20 are realized by software. The program causes a computer to execute the operations of the information processing apparatus 10 or the terminal apparatus 20, thereby causing the computer to function as the information processing apparatus 10 or the terminal apparatus 20. That is, the computer executes the operations of the information processing apparatus 10 or the terminal apparatus 20 in accordance with the program to thereby function as the information processing apparatus 10 or the terminal apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. Instead of transferring a program from the server to the computer, processes may be executed by a so-called ASP type service that realizes functions only by execution instructions and result acquisitions. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the information processing apparatus 10 or terminal apparatus 20 may be realized by a programmable circuit or a dedicated circuit serving as the controller 11 or controller 21. That is, some or all of the functions of the information processing apparatus 10 or terminal apparatus 20 may be realized by hardware.

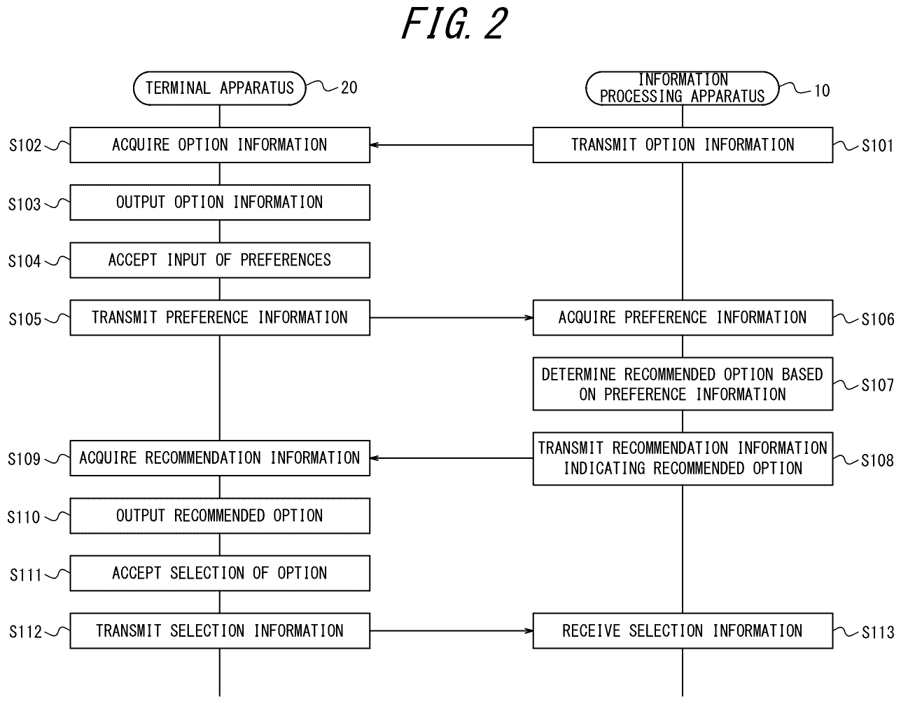

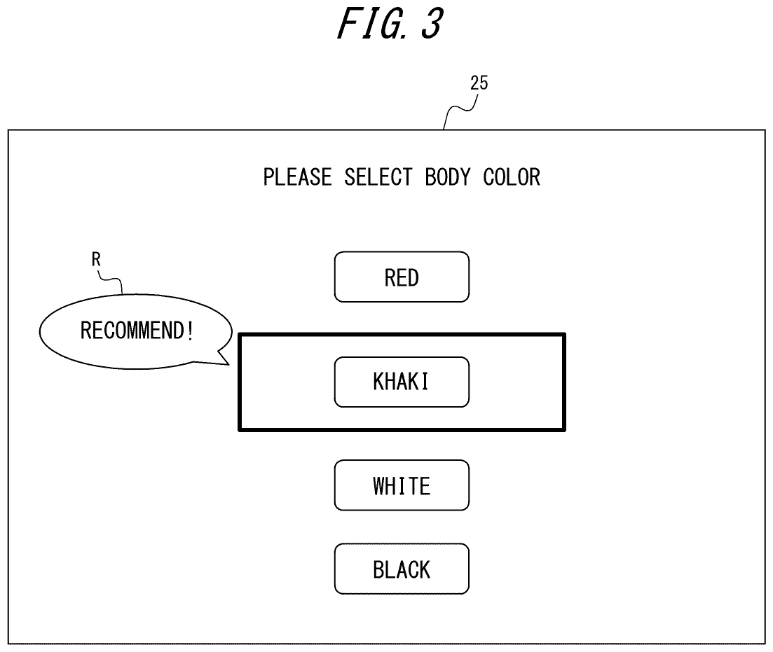

Operations of the system 1 according to the present embodiment will be described with reference to FIGS. 2 and 3. The operations of the terminal apparatus 20, among the operations illustrated in FIG. 2, correspond to a method according to the present embodiment. In the following description, assume that the information processing apparatus 10 communicates with external apparatuses via the communication interface 13 and the network 30, and the terminal apparatus 20 communicates with external apparatuses via the communication interface 23 and the network 30. In this example, it is assumed that the information processing apparatus 10 has acquired information indicating a vehicle for sale that the user is about to purchase.

In S101 of FIG. 2, the controller 11 of the information processing apparatus 10 transmits, to the terminal apparatus 20, option information indicating at least one option. The option information may be preset and stored in the memory 12. In this example, the at least one option is multiple options. The options in the present embodiment are options that can be selected to change standard equipment or specifications that the vehicle for sale has, which is/are set by default. The options are not limited to this, but may be options that can be selected to add to the standard equipment or specifications.

In S102, the controller 21 of the terminal apparatus 20 acquires the option information by receiving the option information.

In S103, the controller 21 outputs, via the output interface 25, the at least one option indicated by the option information. In this example, the multiple options are output.

In S104, the controller 21 accepts input of the user's preferences via the input interface 24. The preferences may be input in text or by the user's operation of selecting at least one choice. For example, a text message asking “What is your main purpose of riding?” may be displayed on the output interface 25. The user may select and input, via the input interface 24, a choice from choices of “for shopping,” “for commuting,” “for drop-off and pick-up,” and the like, and the controller 21 may accept the input.

In S105, the controller 21 generates preference information including the preferences accepted for input in S104, and transmits the preference information to the information processing apparatus 10.

In S106, the controller 11 of the information processing apparatus 10 acquires the preference information by receiving the preference information. The acquisition of the preference information is not limited to this, but may employ any method. For example, the controller 11 may refer to a database in which the preference information for each user is accumulated, which is stored in the memory 12, and acquire the preference information by reading out the preference information. For example, the controller 11 may acquire the preference information by receiving the user's preference information from the user's current vehicle. In this case, a controller of the vehicle may transmit, to the information processing apparatus 10, information indicating destinations entered in a navigation device. The controller 11 of the information processing apparatus 10 may acquire the preference information by receiving such information as the preference information.

In S107, the controller 11 determines, based on the preference information, at least one recommended option from the at least one option indicated by the option information. The determination of the option may employ any method. For example, the controller 11 may determine the recommended option by referring to information in which the preferences indicated by the preference information have already been brought into correspondence with the recommended option. Such information may be stored in advance in the memory 12. For example, it is assumed that a hobby “camping”, as the preference information, has already been brought into correspondence with a body color “khaki”, as the recommended option. When the preference information indicates that the user's hobby is camping, the controller 11 determines, with reference to the information, the body color “khaki” as the recommended option.

For example, the controller 11 may determine the recommended option based on an option selected in the past by another user who has preferences similar to the user's preferences indicated by the preference information. In this case, the controller 11 may refer to information in which, for each of other users, preference information has been brought into correspondence with a purchased option. The controller 11 may identify, from such information, an option purchased by the other user who has preferences similar to the user's preferences, and determine the option as the recommended option. Such information may be stored in advance in the memory 12. For example, the controller 11 may identify the other user whose number of preferences in common with the user's preferences or whose number of preferences in the same category as the user's preferences is equal to or more than a predetermined value. The controller 11 may determine the option in correspondence with the other user, as the recommended option. The predetermined value may be preset and stored in the memory 12. Thus, the option that has been actually purchased by the other user whose preferences are similar to the user's preferences is displayed as a recommendation to the user. This increases the likelihood that the user selects the recommended option.

In S108, the controller 11 transmits, to the terminal apparatus 20, recommendation information indicating the determined recommended option.

In S109, the controller 21 of the terminal apparatus 20 acquires the recommendation information by receiving the recommendation information.

In S110, the controller 21 outputs, via the output interface 25, the recommended option indicated by the recommendation information. FIG. 3 is a diagram illustrating the recommended option for the body color, as displayed on the output interface 25 of the terminal apparatus 20 in this example. In FIG. 3, the body color “khaki,” which is the recommended option, is highlighted with a bold border line. As indicated by a balloon R in FIG. 3, the controller 21 may display, on the output interface 25, the recommended option with a text message such as “Recommend!.”

The controller 21 may further receive and acquire, from the information processing apparatus 10, quotation information indicating a quoted amount when the recommended option is selected, and output the quoted amount via the output interface 25. This makes it easier for the user to understand a price simulation when the user selects the recommended option.

In S111, the controller 21 accepts, via the input interface 24, a selection of an option that the user wishes to purchase.

In S112, the controller 21 transmits, to the information processing apparatus 10, selection information indicating the option selected by the user. The selection information may be information that includes a correspondence between the option selected by the user and the recommended option that has been determined based on the user's preferences and presented to the user.

In S113, the controller 11 of the information processing apparatus 10 receives the selection information, and stores the selection information in the memory 12. Storing and accumulating the selection information in the memory 12 make it possible to verify later whether the option determined based on the user's preferences and presented to the user as the recommended option has been appropriate. The controller 11 performs a sales process of the option, based on the selection of the option by the user. Subsequently, the operations of the system 10 end.

### Second Embodiment

Next, a second embodiment of the present disclosure will be described. A configuration of a system 1 according to the second embodiment is the same as that according to the above first embodiment, so a description thereof is omitted. Configurations of an information processing apparatus 10 and a terminal apparatus 20 according to the second embodiment are the same as those according to the above first embodiment, so descriptions thereof are omitted.

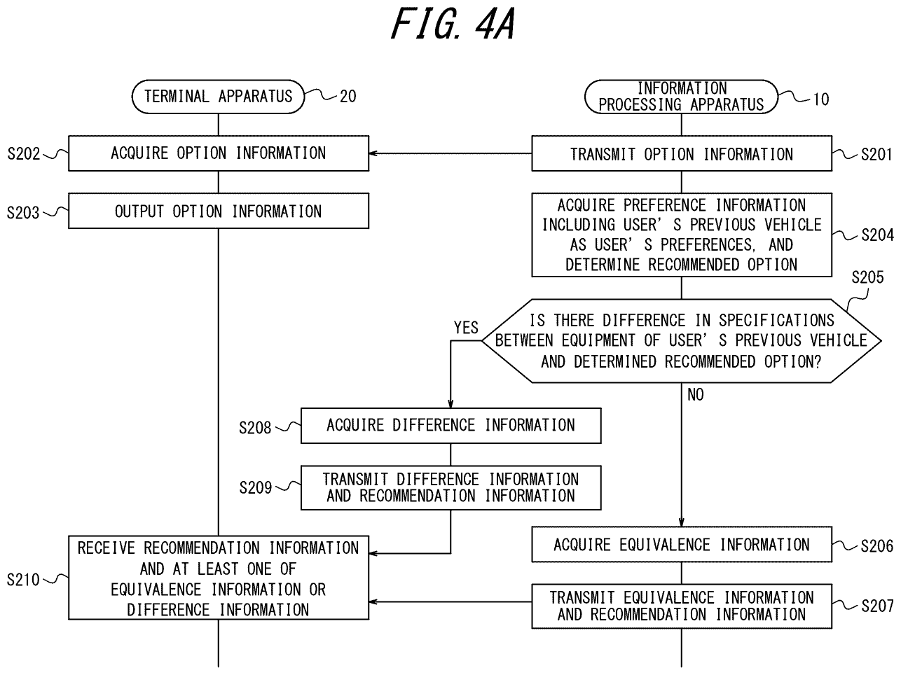

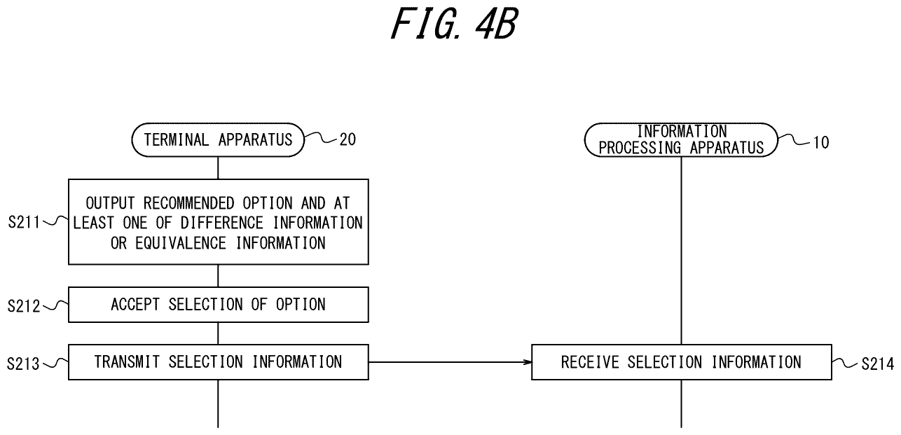

The differences between the operations of the system 1 according to the above embodiment and operations of the system 1 according to the present variation will be described below with reference to FIGS. 4A and 4B.

S201 to S203 of FIG. 4A are the same as S101 to S103 of FIG. 2 according to the above first embodiment, so descriptions thereof are omitted.

In S204, the controller 21 acquires preference information that includes the user's previous vehicle as the user's preferences, and determines a recommended option. The user's previous vehicle may be a vehicle that the user has purchased in the past or a vehicle that the user has used as a rental car.

A case in which the user's previous vehicle is the vehicle that the user has purchased in the past will be described. In this case, the controller 11 acquires information indicating a vehicle purchase history of the user. The controller 11 may acquire the information indicating the past vehicle purchase history of the user by reading the information from the memory 12, or by receiving, from the terminal apparatus 20, the information indicating the vehicle purchase history entered in the terminal apparatus 20 by the user. The controller 11 may acquire such information by receiving the information through communication with a server apparatus of a business operator that has sold the vehicle. The controller 11 further refers to information indicating standard equipment of the vehicle indicated by the vehicle purchase history. Such information may be stored in advance in the memory 12. The controller 11 further refers to information in which such equipment has been in advance brought into correspondence with an option indicated by the option information, and determines the option corresponding to the equipment as the recommended option.

For example, assume that “material A” is a standard seat material of the vehicle indicated by the vehicle purchase history. The controller 11 refers to the information stored in advance in the memory 12 and determines, among options indicated by the option information, an option “material X” for a seat material, which is in correspondence with the “material A”, as the recommended option.

Not limited to this, the controller 11 may refer to a past option purchase history of the user, and determine an option corresponding to the option purchase history as the recommended option. The controller 11 may acquire information indicating such a past option purchase history by reading the information from the memory 12, or by receiving the information through communication with a server apparatus of a business operator that has sold the option.

Next, a case in which the user's previous vehicle is the rental car that the user has used in the past will be described. In this case, the controller 11 acquires information indicating a rental car usage history of the user. The controller 11 may acquire the information indicating the rental car usage history of the user by reading the information from the memory 12, or by receiving, from the terminal apparatus 20, the information indicating the rental car usage history entered in the terminal apparatus 20 by the user. The controller 11 may acquire such information by receiving the information through communication with a server apparatus of a rental car provider. The controller 11 further refers to information indicating standard equipment of a vehicle indicated by the rental car usage history. Such information may be stored in advance in the memory 12. The controller 11 further refers to information in which such equipment has been in advance brought into correspondence with an option indicated by the option information, and determines the option corresponding to the equipment as the recommended option.

Not limited to this, the controller 11 may refer to an equipment usage history for equipment that the user has used when renting the car, and determine an option corresponding to the equipment usage history as the recommended option. The controller 11 may acquire information indicating such a past equipment usage history by reading the information from the memory 12, or by receiving the information through communication with the server apparatus of the rental car provider that the user has used.

For example, assume that the equipment usage history indicates that the equipment the user has used when renting the car is a “child seat size M”. The controller 11 refers to the information stored in advance in the memory 12 and determines, among options indicated by the option information, an option “child seat A type”, which is in correspondence with the “child seat size M”, as the recommended option.

In S205, the controller 11 refers to information indicating specifications of the equipment of the user's previous vehicle and specifications of the determined recommended option, and determines whether there is a difference in the specifications. Such information may be stored in advance in the memory 12. The controller 11 may acquire such information by receiving the information through communication with an external apparatus. The equipment of the user's previous vehicle may be standard equipment of the user's previous vehicle, or may be an option that the user has purchased in the past or that the user has used when renting the car, as described above. The specifications include numerical indicators, the presence or absence of functions, a grade, and the like. When it is determined, as a result of the comparison, that there is no difference, the processing by the controller 11 proceeds to step S206. When it is determined that there is a difference, the processing by the controller 11 proceeds to step S208. The determination of the presence or absence of the difference may employ any appropriate method. For example, the controller 11 may determine that there is no difference when a numerical difference is less than a predetermined value. The controller 11 may determine that there is a difference when the numerical difference is equal to or more than the predetermined value. The predetermined value may be stored in advance in the memory 12.

In S206, the controller 11 acquires equivalence information indicating the equivalence of performance between the equipment of the user's previous vehicle and the recommended option determined in S204. The acquisition of the equivalence information may employ any appropriate method. For example, the controller 11 generates the equivalence information by generating a text message indicating such equivalence. For example, the controller 11 generates the text message “The recommended ‘Child seat A type’ is equivalent to the ‘Child seat M size’ that you have used in the past in the car you have rented,” as the equivalence information.

In step S207, the controller 11 transmits the generated equivalence information to the terminal apparatus 20, together with the recommendation information indicating the recommended option determined in S204.

In S208, the controller 11 acquires difference information indicating the difference in performance between the equipment of the user's previous vehicle and the recommended option determined in S204. The acquisition of the difference information may employ any appropriate method. For example, the controller 11 generates the difference information by generating a text message indicating such difference. For example, assume that the standard equipment of the vehicle purchased by the user in the past is a “rearview monitor Q type”, which does not have the function of displaying guidelines for parking, and that a “rearview monitor R type” determined as the recommended option has such a function. The controller 11 generates and acquires the difference information that says, “There is a function to display guidelines, which is not available in the ‘rearview monitor Q type’ equipped in the vehicle you have purchased in the past”.

In S209, the controller 11 transmits the generated difference information to the terminal apparatus 20, together with the recommendation information indicating the determined recommended option.

In S210, the controller 21 of the terminal apparatus 20 receives, from the information processing apparatus 10, the recommendation information and at least one of the equivalence information or the difference information.

In S211 of FIG. 4B, the controller 21 outputs, via the output interface 25, the recommended option indicated by the recommendation information and at least one of the difference information or the equivalence information.

S212 to S214 are the same as S111 to S113 of FIG. 2 according to the above first embodiment, so descriptions thereof are omitted.

The present disclosure is not limited to the embodiments described above. For example, two or more blocks described in the block diagram may be integrated, or a block may be divided. Instead of executing two or more steps described in the flowcharts in chronological order in accordance with the description, the steps may be executed in parallel or in a different order according to the processing capability of the apparatus that executes each step, or as required. Other modifications can be made without departing from the spirit of the present disclosure.

For example, the controller 21 of the terminal apparatus 20 may accept, via the input interface 24, the user's request as to whether to output the recommended option. The controller 21 may output the recommended option only when the user has requested to do so. The controller 21 may switch the output of the recommended option according to the user's direction. Such a direction for switching may be possible, for example, until the user completes selecting all options. This improves the user's convenience because the recommended option can be displayed only when the user dithers over which option to select.

For example, the controller 11 of the information processing apparatus 10 may transmit, to the terminal apparatus 20, recommended vehicle information indicating a vehicle itself with equipment similar to the user's previous vehicle, as a recommended vehicle. In this case, the controller 11 first transmits, to the terminal apparatus 20, vehicle information indicating multiple vehicles for sale to the user. The controller 11 compares standard equipment of each of the multiple vehicles for sale with standard equipment of the user's previous vehicle, and determines whether there is a difference in the equipment, as in S205 in the above second embodiment. When the number of pieces of the equipment that has been determined to have no difference is equal to or more than a predetermined value, the controller 11 determines the vehicle for sale as the recommended vehicle, and generates the recommended vehicle information indicating the recommended vehicle. The controller 11 transmits the recommended vehicle information to the terminal apparatus 20. The terminal apparatus 20 receives the recommended vehicle information, and outputs the recommended vehicle via the output interface 25. This reduces the likelihood that the user dithers over a selection of a vehicle itself and improves the user's convenience when the user purchases the vehicle.

Examples of some embodiments of the present disclosure are described below. However, it should be noted that the embodiments of the present disclosure are not limited to these examples.
[Appendix 1] A method performed by a terminal apparatus comprising an input interface, an output interface, a communication interface configured to communicate with an information processing apparatus that provides a sales site for options for vehicles, and a controller, the method comprising:
   acquiring, by the controller via the communication interface, recommendation information indicating a recommended option determined based on preference information indicating a user's preference regarding vehicles;
   outputting, by the controller, the recommended option via the output interface;
   accepting, by the controller via the input interface, a selection of an option that the user wishes to purchase; and
   transmitting, by the controller via the communication interface to the information processing apparatus, selection information indicating the option selected by the user.
[Appendix 2] The method according to appendix 1, further comprising accepting, by the controller via the input interface, input of the user's preference, and transmitting, by the controller, the accepted input as the preference information via the communication interface to the information processing apparatus.
[Appendix 3] The method according to appendix 1 or 2, wherein the preference information includes a purpose of riding of the user.
[Appendix 4] The method according to any one of appendices 1 to 3, wherein the recommendation information includes the recommended option determined based on a vehicle purchase history of the user.
[Appendix 5] The method according to any one of appendices 1 to 4, wherein the recommendation information includes the recommended option determined based on a rental car usage history of the user.
[Appendix 6] The method according to appendix 4 or 5, wherein
   the recommendation information includes the recommended option having equivalence of performance with equipment provided in a vehicle that the user has ridden in past, and
   the method further comprises:
      acquiring, by the controller, equivalence information indicating the equivalence; and
      outputting, by the controller via the output interface, the recommended option having the equivalence.
[Appendix 7] The method according to any one of appendices 4 to 6, wherein
   the recommendation information includes the recommended option having a difference in performance from equipment provided in a vehicle that the user has ridden in past, and
   the method further comprises:
      acquiring, by the controller, difference information indicating the difference in performance; and
      outputting, by the controller via the output interface, the recommended option having the difference in performance.
[Appendix 8] The method according to any one of appendices 1 to 7, wherein the recommended option includes an option that has been selected in past by another user different from the user, the other user having a preference similar to the user's preference regarding the vehicles.
[Appendix 9] The method according to any one of appendices 1 to 8, further comprising accepting, by the controller via the input interface, a request from the user as to whether to output the recommended option.
[Appendix 10] A terminal apparatus comprising:
   an input interface;
   an output interface;
   a communication interface configured to communicate with an information processing apparatus that provides a sales site for options for vehicles; and
   a controller configured to:
      acquire, via the communication interface, recommendation information indicating a recommended option determined based on preference information indicating a user's preference regarding vehicles;
      output the recommended option via the output interface;
      accept, via the input interface, a selection of an option that the user wishes to purchase; and
      transmit, via the communication interface to the information processing apparatus, selection information indicating the option selected by the user.
[Appendix 11] The terminal apparatus according to appendix 10, wherein the controller is configured to accept, via the input interface, input of the user's preference, and transmit the accepted input as the preference information via the communication interface to the information processing apparatus.
[Appendix 12] The terminal apparatus according to appendix 10 or 11, wherein the preference information includes a purpose of riding of the user.
[Appendix 13] The terminal apparatus according to any one of appendices 10 to 12, wherein the recommendation information includes the recommended option determined based on a vehicle purchase history of the user.
[Appendix 14] The terminal apparatus according to any one of appendices 10 to 13, wherein the recommendation information includes the recommended option determined based on a rental car usage history of the user.
[Appendix 15] The terminal apparatus according to appendix 13 or 14, wherein
   the recommendation information includes the recommended option having equivalence of performance with equipment provided in a vehicle that the user has ridden in past, and
   the controller is configured to:
      acquire equivalence information indicating the equivalence; and
      output, via the output interface, the recommended option having the equivalence.
[Appendix 16] The terminal apparatus according to any one of appendices 13 to 15, wherein
   the recommendation information includes the recommended option having a difference in performance from equipment provided in a vehicle that the user has ridden in past, and
   the controller is configured to:
      acquire difference information indicating the difference in performance; and
      output, via the output interface, the recommended option having the difference in performance.
[Appendix 17] The terminal apparatus according to any one of appendices 10 to 16, wherein the recommended option includes an option that has been selected in past by another user different from the user, the other user having a preference similar to the user's preference regarding the vehicles.
[Appendix 18] The terminal apparatus according to any one of appendices 10 to 17, wherein the controller is configured to accept, via the input interface, a request from the user as to whether to output the recommended option.
[Appendix 19] A program configured to cause a computer as a terminal apparatus to execute operations, the terminal apparatus comprising an input interface, an output interface, a communication interface configured to communicate with an information processing apparatus that provides a sales site for options for vehicles, and a controller, the operations comprising:
   acquiring, via the communication interface, recommendation information indicating a recommended option determined based on preference information indicating a user's preference regarding vehicles;
   outputting the recommended option via the output interface;
   accepting, via the input interface, a selection of an option that the user wishes to purchase; and
   transmitting, via the communication interface to the information processing apparatus, selection information indicating the option selected by the user.
[Appendix 20] The program according to appendix 19, wherein the operations further comprise accepting, via the input interface, input of the user's preference, and transmitting the accepted input as the preference information via the communication interface to the information processing apparatus.

1. A method performed by a terminal apparatus comprising an input interface, an output interface, a communication interface configured to communicate with an information processing apparatus that provides a sales site for options for vehicles, and a controller, the method comprising:
acquiring, by the controller via the communication interface, recommendation information indicating a recommended option determined based on preference information indicating a user's preference regarding vehicles;
outputting, by the controller, the recommended option via the output interface;
accepting, by the controller via the input interface, a selection of an option that the user wishes to purchase; and
transmitting, by the controller via the communication interface to the information processing apparatus, selection information indicating the option selected by the user.

2. The method according to claim 1, further comprising accepting, by the controller via the input interface, input of the user's preference, and transmitting, by the controller, the accepted input as the preference information via the communication interface to the information processing apparatus.

3. The method according to claim 1, wherein the preference information includes a purpose of riding of the user.

4. The method according to claim 1, wherein the recommendation information includes the recommended option determined based on a vehicle purchase history of the user.

5. The method according to claim 1, wherein the recommendation information includes the recommended option determined based on a rental car usage history of the user.

6. The method according to claim 4, wherein
the recommendation information includes the recommended option having equivalence of performance with equipment provided in a vehicle that the user has ridden in past, and
the method further comprises:
acquiring, by the controller, equivalence information indicating the equivalence; and
outputting, by the controller via the output interface, the recommended option having the equivalence.

7. The method according to claim 4, wherein
the recommendation information includes the recommended option having a difference in performance from equipment provided in a vehicle that the user has ridden in past, and
the method further comprises:
acquiring, by the controller, difference information indicating the difference in performance; and
outputting, by the controller via the output interface, the recommended option having the difference in performance.

8. The method according to claim 1, wherein the recommended option includes an option that has been selected in past by another user different from the user, the other user having a preference similar to the user's preference regarding the vehicles.

9. The method according to claim 1, further comprising accepting, by the controller via the input interface, a request from the user as to whether to output the recommended option.

10. A terminal apparatus comprising:
an input interface;
an output interface;
a communication interface configured to communicate with an information processing apparatus that provides a sales site for options for vehicles; and
a controller configured to:
acquire, via the communication interface, recommendation information indicating a recommended option determined based on preference information indicating a user's preference regarding vehicles;
output the recommended option via the output interface;
accept, via the input interface, a selection of an option that the user wishes to purchase; and
transmit, via the communication interface to the information processing apparatus, selection information indicating the option selected by the user.

11. The terminal apparatus according to claim 10, wherein the controller is configured to accept, via the input interface, input of the user's preference, and transmit the accepted input as the preference information via the communication interface to the information processing apparatus.

12. The terminal apparatus according to claim 10, wherein the preference information includes a purpose of riding of the user.

13. The terminal apparatus according to claim 10, wherein the recommendation information includes the recommended option determined based on a vehicle purchase history of the user.

14. The terminal apparatus according to claim 10, wherein the recommendation information includes the recommended option determined based on a rental car usage history of the user.

15. The terminal apparatus according to claim 13, wherein
the recommendation information includes the recommended option having equivalence of performance with equipment provided in a vehicle that the user has ridden in past, and
the controller is configured to:
acquire equivalence information indicating the equivalence; and
output, via the output interface, the recommended option having the equivalence.

16. The terminal apparatus according to claim 13, wherein
the recommendation information includes the recommended option having a difference in performance from equipment provided in a vehicle that the user has ridden in past, and
the controller is configured to:
acquire difference information indicating the difference in performance; and
output, via the output interface, the recommended option having the difference in performance.

17. The terminal apparatus according to claim 10, wherein the recommended option includes an option that has been selected in past by another user different from the user, the other user having a preference similar to the user's preference regarding the vehicles.

18. The terminal apparatus according to claim 10, wherein the controller is configured to accept, via the input interface, a request from the user as to whether to output the recommended option.

19. A non-transitory computer readable medium storing a program configured to cause a computer as a terminal apparatus to execute operations, the terminal apparatus comprising an input interface, an output interface, a communication interface configured to communicate with an information processing apparatus that provides a sales site for options for vehicles, and a controller, the operations comprising:
acquiring, via the communication interface, recommendation information indicating a recommended option determined based on preference information indicating a user's preference regarding vehicles;
outputting the recommended option via the output interface;
accepting, via the input interface, a selection of an option that the user wishes to purchase; and
transmitting, via the communication interface to the information processing apparatus, selection information indicating the option selected by the user.

20. The non-transitory computer readable medium according to claim 19, wherein the operations further comprise accepting, via the input interface, input of the user's preference, and transmitting the accepted input as the preference information via the communication interface to the information processing apparatus.
